(19) United States
(12) Patent Application Publication
(10) Pub. No.: US 2020/0298660 A1
(43) Pub. Date: Sep. 24, 2020

(54) BLOW UNIT OF AIR CONDITIONER FOR VEHICLE

(71) Applicant: Hanon Systems, Daejeon (KR)

(72) Inventors: Hwan Kyu CHO, Daejeon (KR); In Keun KANG, Daejeon (KR); Jae Woo KO, Daejeon (KR); Young Keun KIM, Daejeon (KR); Tae Yeong PARK, Daejeon (KR); Chang Soo BAE, Daejeon (KR); Sung Hoon SONG, Daejeon (KR); Jong Min LEE, Daejeon (KR); Ki Man JEON, Daejeon (KR); Gyu Ik HAN, Daejeon (KR); Heon HUR, Daejeon (KR)

(21) Appl. No.: 16/704,511

(22) Filed: Dec. 5, 2019

(30) Foreign Application Priority Data
Dec. 7, 2018 (KR) 10-2018-0156646

(51) Int. Cl. B60H 1/00; F04D 17/10

(52) U.S. Cl. CPC B60H 1/00849; B60H 1/12; B60H 2001/00178; F04D 17/105

(57) ABSTRACT

The present invention relates to a blower unit of an air conditioner for a vehicle, which can enhance air-conditioning performance through uniform upper and lower pressure control since compensating and supplementing different air resistances between an upper scroll case and a lower scroll case. The blower unit of the two-layered air conditioner for a vehicle, which separates and blows indoor air and outdoor air, includes: a first scroll in which a first blower wheel is disposed and a first air passageway is formed; and a second scroll arranged below the first scroll, and having a second blower wheel and a second air passageway, wherein a diameter of the second blower wheel and a diameter of the first blower wheel are different from each other.

### BLOWER UNIT OF AIR CONDITIONER FOR VEHICLE

This application claims priority from Korean Patent Application No. 10-2018-0156646 filed on Dec. 7, 2018. The entire contents of this application is incorporated herein by reference in its entirety.

The patent or application file contains two drawings executed in color. Copies of this patent or patent application publication with color drawing(s) will be provided by the Office upon request and payment of the necessary fee.

### BACKGROUND OF THE INVENTION

### Field of the Invention

The present invention relates to a blower unit of an air conditioner for a vehicle, and more particularly, to a blower unit of a two-layered air conditioner for a vehicle, which can selectively inhale indoor air or outdoor air into an air-conditioning case, thereby securing defogging performance and maintaining high heating performance during heating.

### Background Art

In general, an air conditioner for a vehicle is a device for heating or cooling the interior of the vehicle by introducing outdoor air to the interior of the vehicle or circulating indoor air to heat or cool. The air conditioner for a vehicle includes a blower unit for introducing and blowing indoor air or outdoor air, and an air-conditioning unit for conditioning the air blown from the blower unit and discharging the air to the interior of the vehicle.

Especially, a two-layered air conditioner has been developed in order to secure defogging performance and maintain high heating performance during heating. Cold outdoor air of low humidity is effective to defrost windows during traveling in a heating state, but it results in lowering indoor temperature.

The two-layered air conditioner realizes a two-layer air flow of indoor air and outdoor air to supply outdoor air to an upper part of a vehicle and circulate indoor air to a lower part of the vehicle in order to defog in the heating state, thereby effectively defrosting using fresh outdoor air of low humidity supplied to the upper part, offering fresh air to passengers, and maintaining high heating performance by supplying warm indoor air to the lower part.

FIG. 1 is a sectional view showing an air-conditioning unit of a conventional two-layered air conditioner for a vehicle. Referring to FIG. 1, the air-conditioning unit 5 of the conventional two-layered air conditioner for a vehicle includes an air-conditioning case 10. The air-conditioning case 10 includes an air passageway of a predetermined shape formed therein, and the air passageway is partitioned into an upper passageway 21 and a lower passageway 22 by a separation wall 23. The air-conditioning case 10 has a plurality of air outlets formed at an exit of the air-conditioning case 10. The air outlets include a defrost vent 16, a face vent 17, a front seat floor vent 18, and a rear seat floor vent 19.

A blower unit is combined with an air inlet 15 of the air-conditioning case 10, and an evaporator 2 and a heater core 3 are disposed in the air passageway of the air-conditioning case 10 to be spaced apart from each other at a predetermined interval. Outdoor air is introduced into the upper passageway 21 and flows in the upper passageway 21, and indoor air is introduced into the lower passageway 22 and flows in the lower passageway 22. A first temp door 11 for adjusting an amount of air passing the heater core 3 and an amount of air bypassing the heater core 3 is disposed in the upper passageway 21. A second temp door 12 for adjusting the amount of the air passing the heater core 3 and the amount of the air bypassing the heater core 3 is disposed in the lower passageway 22.

A defrost door 24 and a face door 25 are respectively disposed at the air outlets in order to adjust an amount of air discharged to the defrost vent 16 and the face vent 17. A floor door 26 for adjusting an amount of air discharged to the front seat floor vent 18 and a rear seat mode door 27 for adjusting an amount of air discharged to the rear seat floor vent 19 are respectively disposed at the air outlets. A bypass door 28 for controlling communication between the upper passageway 21 and the lower passageway 22 is disposed so that the indoor air of the lower passageway 22 can flow to the upper passageway 21.

FIG. 2 is a sectional view showing a blower unit of the conventional two-layered air conditioner for a vehicle. Referring to FIG. 2, the blower unit 7 of the conventional two-layered air conditioner for a vehicle includes a blower case, a blower wheel, a blower motor 76, and an air filter 75.

The blower case includes an intake case 82 and a scroll case 70 joined to a lower portion of the intake case 82. The intake case 82 includes an indoor air inlet 72 for introducing indoor air and an outdoor air inlet 71 for introducing outdoor air. The indoor air inlet 72 and the outdoor air inlet 71 are formed at an upper portion of the intake case 82. An indoor air door 74 adjusts the degree of opening of the indoor air inlet 72, and an outdoor air door 73 adjusts the degree of opening of the outdoor air inlet 71.

The blower wheel and the blower motor 76 are disposed in the scroll case 70 and send the air introduced through the indoor air inlet 72 and the outdoor air inlet 71 to the interior of the vehicle. The air filter 75 is disposed at the upstream side of the blower wheel in an air flow direction. The air passageway of the scroll case 70 is divided into a first air passageway 79, in which outdoor air flows, and a second air passageway 80, in which indoor air flows, by a separation wall 81. The blower wheel includes a first blower wheel 77 disposed in the first air passageway 79 and a second blower wheel 78 disposed in the second air passageway 80.

The outdoor air introduced into the outdoor air inlet 71 flows to the first air passageway 79 through a first inlet 86 and is blown to the upper passageway 21 of the air-conditioning unit 5. Moreover, the indoor air introduced into the indoor air inlet 72 flows to the second air passageway 80 through the second inlet 85 and is blown to the lower passageway 22 of the air-conditioning unit 5.

FIG. 3 is a perspective view showing the scroll case of the blower unit of the conventional two-layered air conditioner for a vehicle, FIG. 4 is a perspective view showing a state where the scroll case of the blower unit of the conventional two-layered air conditioner for a vehicle is separated, and FIG. 5 is a plan view showing the scroll case of the blower unit of the conventional two-layered air conditioner for a vehicle.

Referring to FIGS. 3 to 5, the scroll case 70 includes an upper scroll case 83, and a lower scroll case 84 joined to a lower portion of the upper scroll case 83. The first air passageway 79 is formed in the scroll case 83, and the first blower wheel 77 is disposed in the upper scroll case 83. The second air passageway 80 is formed in the lower scroll case 84, and the second blower wheel 78 is disposed in the lower scroll case 84.

The upper scroll case 83 and the lower scroll case 84 have a spiral form of which a diameter gets larger on the basis of the blower wheels. That is, the scroll case is formed by a predetermined scroll expansion angle applied along the “11” line indicated by the chain line of FIG. 5 from the “cut off” point which is a start point of the spiral form.

The scroll case 70 of the blower unit of the conventional air conditioner for a vehicle has different ventilation resistance between the passageway (the first air passageway) of the upper scroll case 83 and the passageway (the second air passageway) of the lower scroll case 84, but the conventional air conditioner for a vehicle has a disadvantage in that air-conditioning performance since the same scroll expansion angle is applied to the upper scroll case 83 and the lower scroll case 84.

In the meantime, FIG. 6 is a front view showing the scroll case of the blower unit of the conventional two-layered air conditioner for a vehicle is separated. Referring to FIG. 6, the upper scroll case 83 and the lower scroll case 84 have scroll development parts that the air passageways are expanded downstream toward the air outlets in the air flow direction. The scroll development parts of the conventional upper scroll case 83 and lower scroll case 84 have the same start point. That is, a length (a) from the start point of the scroll development part of the upper scroll case to the air outlets is equal to a length (b) from the start point of the scroll development part of the lower scroll case to the air outlets.

The scroll case 70 of the blower unit of the conventional air conditioner for a vehicle has different ventilation resistance between the passageway of the upper scroll case 83 and the passageway of the lower scroll case 84, but the conventional air conditioner for a vehicle has a disadvantage in that air-conditioning performance since the scroll development parts of the upper scroll case 83 and the lower scroll case 84 have the same start point.

### SUMMARY OF THE INVENTION

Accordingly, the present invention has been made to solve the above-mentioned problems occurring in the prior arts, and it is an object of the present invention to provide a blower unit of an air conditioner for a vehicle, which can enhance air-conditioning performance through uniform upper and lower pressure control since compensating and supplementing different air resistances between an upper scroll case and a lower scroll case.

To accomplish the above object, according to the present invention, there is provided a blower unit of a two-layered air conditioner for a vehicle, which separates and blows indoor air and outdoor air, including: a first scroll in which a first blower wheel is disposed and a first air passageway is formed; and a second scroll arranged below the first scroll, and having a second blower wheel and a second air passageway, wherein a diameter of the second blower wheel and a diameter of the first blower wheel are different from each other.

Moreover, the diameter of the second blower wheel is larger than that of the first blower wheel.

Furthermore, a scroll expansion angle of the first scroll and a scroll expansion angle of the second scroll are different from each other.

Additionally, the scroll expansion angle of the second scroll is larger than that of the first scroll.

In addition, a height of the first blower wheel is greater than a height of the second blower wheel.

Moreover, the scroll expansion angles of the first scroll and the second scroll are formed in such a way that a distance between the center of the blower wheel and the outer wall surface gets farther from a “cut off” point.

Furthermore, the scroll expansion angle of the first scroll is 5.2° to 5.8°, and the scroll expansion angle of the second scroll is 6.0° to 6.6°.

In another aspect of the present invention, there is provided a blower unit of a two-layered air conditioner for a vehicle, which separates and blows indoor air and outdoor air, including: a first scroll in which a first blower wheel is disposed and a first air passageway is formed; and a second scroll arranged below the first scroll, and having a second blower wheel and a second air passageway, wherein a start point of a scroll development part of the first scroll and a start point of a scroll development part of the second scroll are different from each other.

Additionally, the start point of the scroll development part of the first scroll in the air flow direction is formed to be further back than the start point of the scroll development part of the second scroll.

In addition, the air passageway of the second scroll is more complicated than the air passageway of the first scroll.

Moreover, the air passageway of the second scroll is larger in air resistance than the air passageway of the first scroll.

Furthermore, the first scroll includes an upper scroll case, and the second scroll includes a lower scroll case joined below the upper scroll case. The upper scroll case receives the air which is introduced into the blower unit and directly flows downwards, and the lower scroll case receives the air which is introduced into the blower unit, flows downwards and bypasses and flows upwards.

The blower unit of the air conditioner for a vehicle according to the present invention can enhance air-conditioning performance, make speed distribution uniform, and improve a noise problem through uniform upper and lower pressure control.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sectional view showing an air-conditioning unit of a conventional two-layered air conditioner for a vehicle;

FIG. 2 is a sectional view showing a blower unit of the conventional two-layered air conditioner for a vehicle;

FIG. 3 is a perspective view showing a scroll case of the blower unit of the conventional two-layered air conditioner for a vehicle;

FIG. 4 is a perspective view showing a state where the scroll case of the blower unit of the conventional two-layered air conditioner for a vehicle is separated;

FIG. 5 is a plan view showing the scroll case of the blower unit of the conventional two-layered air conditioner for a vehicle;

FIG. 6 is a front view showing the scroll case of the blower unit of the conventional two-layered air conditioner for a vehicle is separated;

FIG. 7 is a sectional view showing an air conditioning unit of a two-layered air conditioner for a vehicle according to an embodiment of the present invention;

FIG. 8 is a sectional view showing a blower unit of the two-layered air conditioner for a vehicle according to the embodiment of the present invention;

FIG. 9 is a perspective view showing a scroll case of the two-layered air conditioner for a vehicle according to the embodiment of the present invention;

FIG. 10 is a perspective view showing a state where the scroll case is separated;

FIG. 11 is a plan view showing the scroll case of the two-layered air conditioner for a vehicle according to the embodiment of the present invention;

FIG. 12 is a view showing a blower wheel of the two-layered air conditioner for a vehicle according to the embodiment of the present invention;

FIG. 13 is a graph for explaining a scroll expansion angle of the two-layered air conditioner for a vehicle according to the embodiment of the present invention;

FIG. 14 is a graph for explaining an air-conditioning performance improvement result according to the scroll expansion angle;

FIG. 15A is a graph for explaining an air-conditioning performance improvement result according to the scroll expansion angle, showing a non-uniform speed distribution.

FIG. 15B is a graph for explaining an air-conditioning performance improvement result according to the scroll expansion angle, showing a relatively uniform speed distribution.

FIG. 16 is a front view showing a state where the scroll case is separated; and

FIG. 17A is a graph for explaining an air-conditioning performance improvement result according to a start point of a scroll development part according to the embodiment of the present invention, showing a non-uniform speed distribution.

FIG. 17B is a graph for explaining an air-conditioning performance improvement result according to a start point of a scroll development part according to the embodiment of the present invention, showing a relatively uniform speed distribution.

FIG. 18 is a graph for explaining an air-conditioning performance improvement result according to a start point of a scroll development part according to the embodiment of the present invention.

FIG. 19 is a graph for explaining an air-conditioning performance improvement result according to a start point of a scroll development part according to the embodiment of the present invention.

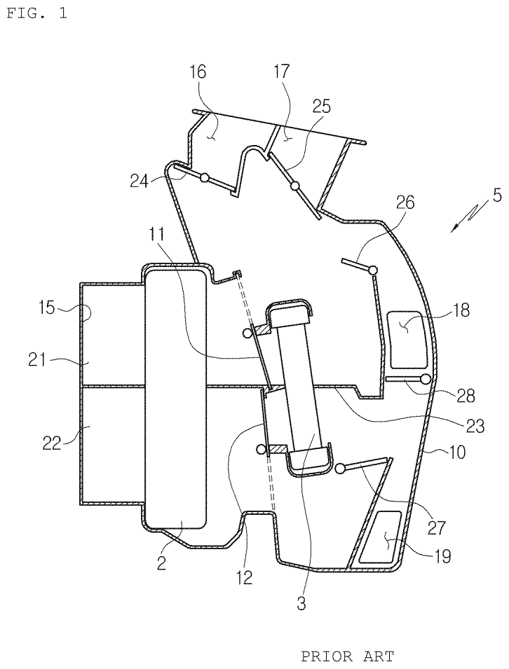

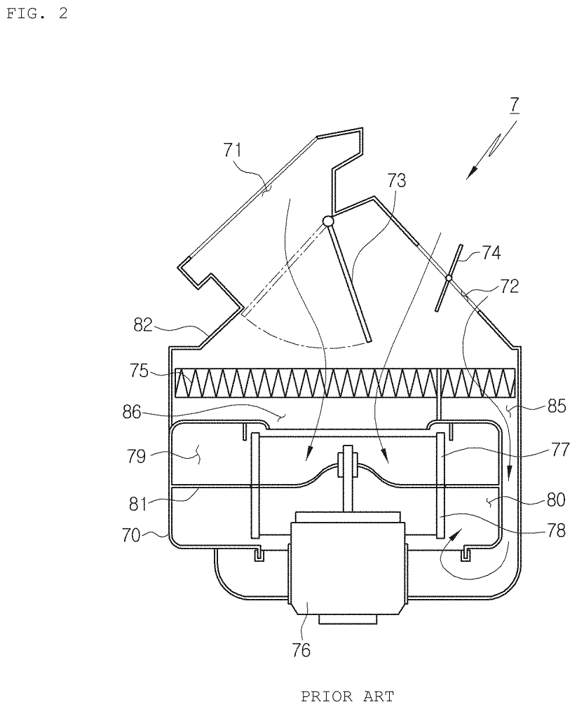

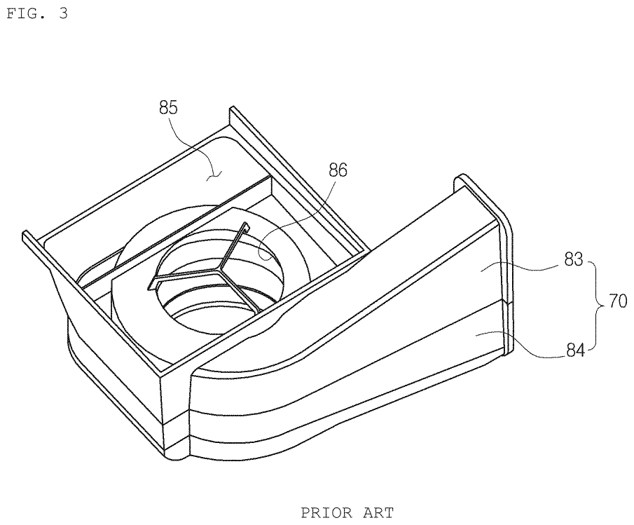

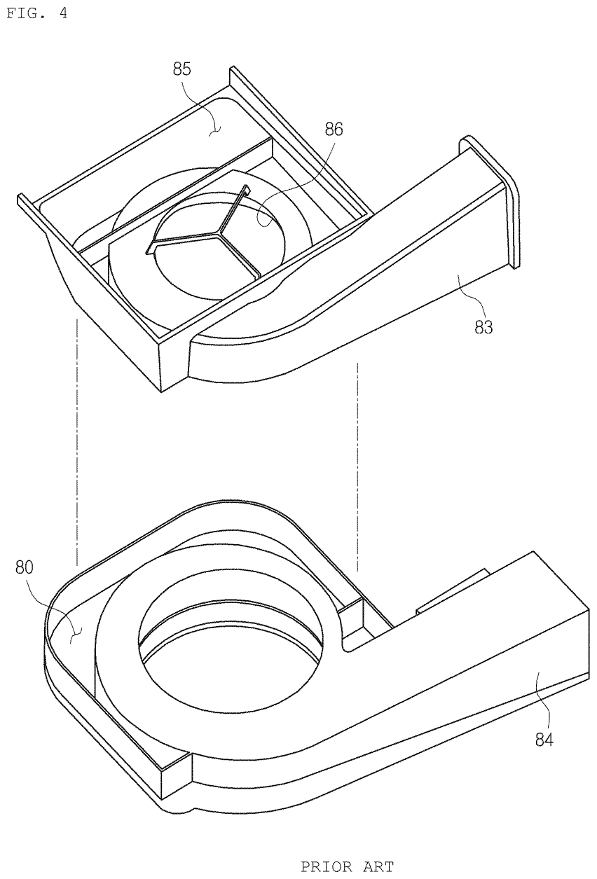

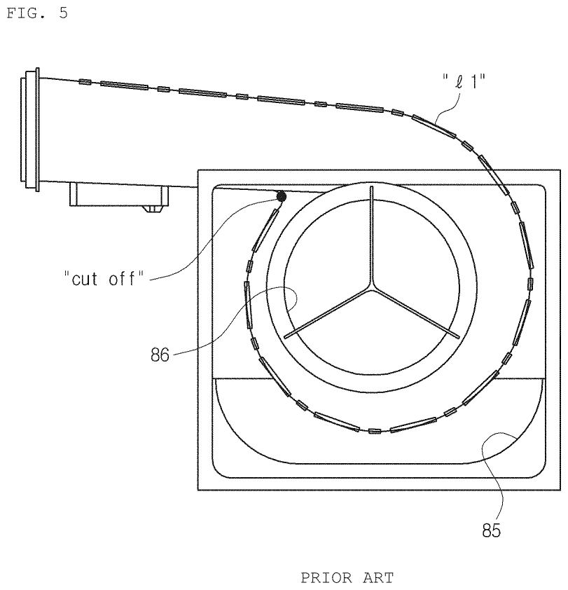

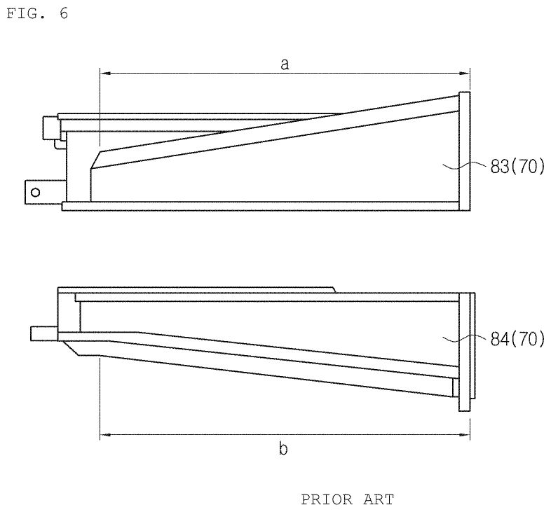

### DETAILED DESCRIPTION OF THE PREFERRED EMBODIMENT

Hereinafter, with reference to the attached drawings, a technical structure of a blower unit of an air conditioner for a vehicle according to a preferred embodiment of the present invention will be described in detail.

A two-layered air conditioner for a vehicle according to an embodiment of the present invention is a device for heating or cooling the interior of the vehicle by introducing outdoor air into the interior of the vehicle or circulating indoor air, and includes a blower unit for introducing and blowing indoor air or outdoor air, and an air-conditioning unit for conditioning the air blown from the blower unit and discharging the air to the interior of the vehicle. The two-layered air conditioner for a vehicle divides and blows the indoor air and the outdoor air in order to secure defogging performance and maintain high heating performance during heating.

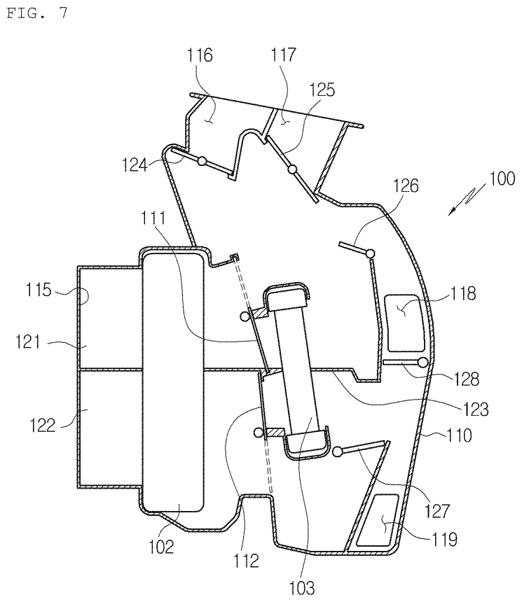

FIG. 7 is a sectional view showing the air conditioning unit of the two-layered air conditioner for a vehicle according to the embodiment of the present invention. Referring to FIG. 7, the air-conditioning unit 100 of the two-layered air conditioner for a vehicle according to the embodiment of the present invention includes an air-conditioning case 110. The air-conditioning case 110 includes an air passageway of a predetermined form therein, and the air passageway is partitioned into an upper passageway 121 and a lower passageway 122 by a separation wall 123. The air-conditioning case 110 has a plurality of air outlets formed at an exit thereof. The air outlets include a defrost vent 116, a face vent 117, a front seat floor vent 118, and a rear seat floor vent 119.

The blower unit 110 is combined with an air inlet 115 of the air-conditioning case 110, and an evaporator 102 and a heater core 103 are disposed in the air passageway of the air-conditioning case 110 to be spaced apart from each other at a predetermined interval. Outdoor air is introduced into the upper passageway 121 and flows in the upper passageway 121, and indoor air is introduced into the lower passageway 122 and flows in the lower passageway 122. A first temp door 111 for adjusting an amount of air passing the heater core 103 and an amount of air bypassing the heater core 103 is disposed in the upper passageway 121. A second temp door 112 for adjusting the amount of the air passing the heater core 103 and the amount of the air bypassing the heater core 103 is disposed in the lower passageway 122.

A defrost door 124 and a face door 125 are respectively disposed at the air outlets in order to adjust an amount of air discharged to the defrost vent 116 and the face vent 117. A floor door 126 for adjusting an amount of air discharged to the front seat floor vent 118 and a rear seat mode door 127 for adjusting an amount of air discharged to the rear seat floor vent 119 are respectively disposed at the air outlets. A bypass door 128 for controlling communication between the upper passageway 121 and the lower passageway 122 is disposed so that the indoor air of the lower passageway 122 can flow to the upper passageway 121.

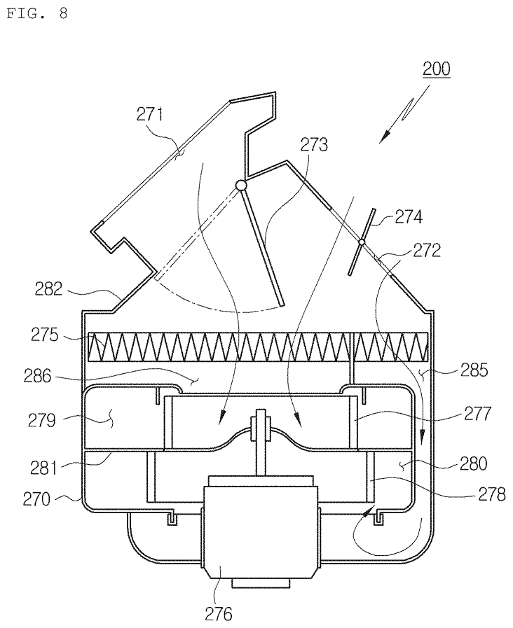

FIG. 8 is a sectional view showing the blower unit of the two-layered air conditioner for a vehicle according to the embodiment of the present invention. Referring to FIG. 8, the blower unit 200 of the two-layered air conditioner for a vehicle according to the embodiment of the present invention includes a blower case, a blower wheel, a blower motor 276, and an air filter 275.

The blower case includes an intake case 282, and a scroll case 270 joined to a lower portion of the intake case 282. The intake case 282 includes an indoor air inlet 272 for introducing indoor air and an outdoor air inlet 271 for introducing outdoor air. The indoor air inlet 272 and the outdoor air inlet 271 are formed at an upper portion of the intake case 282. An indoor air door 274 adjusts the degree of opening of the indoor air inlet 272, and an outdoor air door 273 adjusts the degree of opening of the outdoor air inlet 271.

The blower wheel and the blower motor 276 are disposed in the scroll case 270 and send the air introduced through the indoor air inlet 272 and the outdoor air inlet 271 to the interior of the vehicle. The air filter 275 is disposed at the upstream side of the blower wheel in an air flow direction. The air passageway of the scroll case 270 is divided into a first air passageway 279, in which outdoor air flows, and a second air passageway 280, in which indoor air flows, by a separation wall 281. The blower wheel includes a first blower wheel 277 disposed in the first air passageway 279 and a second blower wheel 278 disposed in the second air passageway 280.

The outdoor air introduced into the outdoor air inlet 271 flows to the first air passageway 279 through a first inlet 286 and is blown to the upper passageway 121 of the air-conditioning unit 100. Moreover, the indoor air introduced into the indoor air inlet 272 flows to the second air passageway 280 through the second inlet 285 and is blown to the lower passageway 122 of the air-conditioning unit 100.

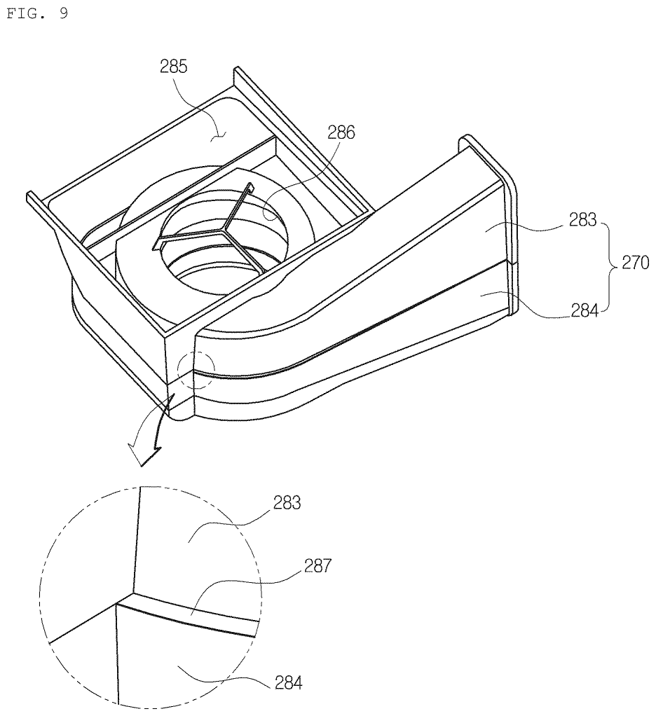

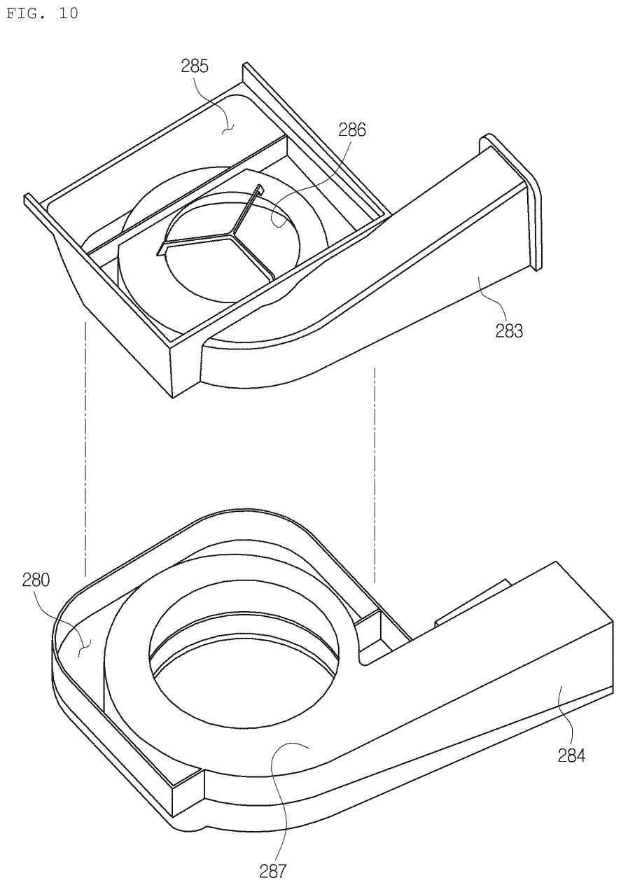

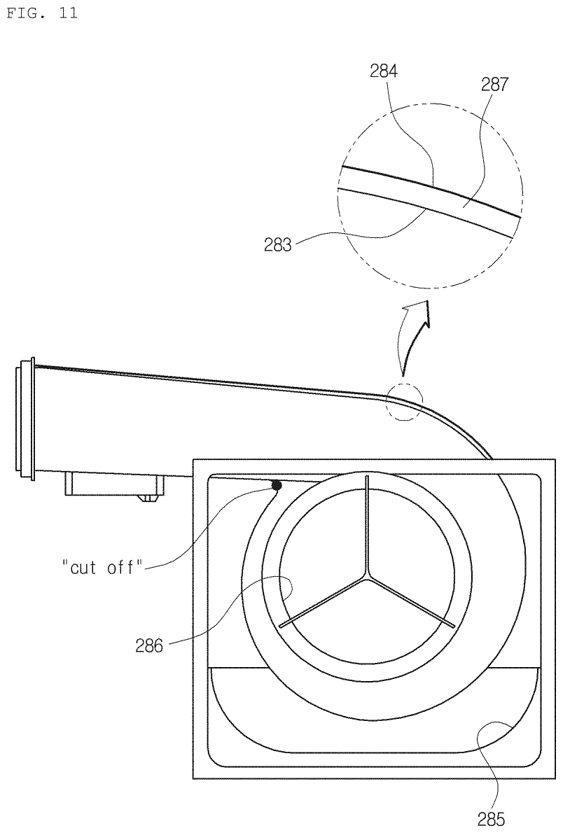

FIG. 9 is a perspective view showing a scroll case of the two-layered air conditioner for a vehicle according to the embodiment of the present invention, FIG. 10 is a perspective view showing a state where the scroll case is separated, and FIG. 11 is a plan view showing the scroll case of the two-layered air conditioner for a vehicle according to the embodiment of the present invention.

Referring to FIGS. 9 to 11, the scroll case 270 includes a first scroll and a second scroll. The first scroll includes an upper scroll case 283, and the second scroll includes a lower scroll case 284. The lower scroll case 284 is joined to a lower portion of the upper scroll case 283. The first air passageway 279 is formed in the upper scroll case 283, and the first blower wheel 277 is disposed in the upper scroll case 283. The second air passageway 280 is formed in the lower scroll case 284, and the second blower wheel 278 is disposed in the lower scroll case 284.

The air passageway of the second scroll, namely, the second air passageway 280 is more complicated than the air passageway of the first scroll, namely, the first air passageway 279. That is, the second air passageway 280 is greater in air resistance than the first air passageway 279. In detail, the upper scroll case 283 receives the air which is introduced into the blower unit and directly flows downwards. Moreover, the lower scroll case 284 receives the air, which is introduced into the blower unit, flows downwards and bypasses and flows upwards.

In more detail, the outdoor air introduced through the outdoor air inlet 271 passes the air filter 275 to be filtered, moves downwards, and then, flows into the first scroll case 283 through the first inlet 286. The outdoor air flowing into the first air passageway 279, which has flown in a vertical direction, flows in a radial direction by rotation of the first blower wheel 277, and then, flows into the air-conditioning unit 100 through a scroll development duct of the first scroll case 283.

Furthermore, the indoor air introduced through the indoor air inlet 273 passes the air filter 275 to be filtered, moves downwards, and continuously moves downwards along the outer face of a side wall of the scroll case through the second inlet 285, and then, makes a U-turn to move upwards. After that, the indoor air moves into the second scroll case 284. The outdoor air flowing into the second air passageway 280, which has flown in the vertical direction, flows in the radial direction by rotation of the second blower wheel 278, and then, flows into the air-conditioning unit 100 through a scroll development duct of the second scroll case 284.

The upper scroll case 283 and the lower scroll case 284 have a spiral form of which a diameter gets larger on the basis of the blower wheels. That is, the first scroll case and the second scroll are is formed by a predetermined scroll expansion angle applied along a path of an outer wall surface of the scroll case from the “cut off” point which is a start point of the spiral form. The expansion angles of the first scroll and the second scroll are formed in such a way that a distance between the center of the blower wheel and the outer wall surface gets farther from the “cut off” point which is the start point.

Especially, the scroll expansion angle of the first scroll and the scroll expansion angle of the second scroll are different from each other. Preferably, the expansion angle of the second scroll is larger than the expansion angle of the first scroll. It is preferable that the expansion angle of the first scroll be 5.2° to 5.8° and the expansion angle of the second scroll be 6.0° to 6.6°. More preferably, the expansion angle of the first scroll is 5.5° and the expansion angle of the second scroll is 6.3°.

If the expansion angle of the lower scroll case 284 is larger than the expansion angle of the upper scroll case 283, as shown in FIGS. 9 and 11, a scroll development duct upper surface 287 of the lower scroll case 284 protrudes outwards from the upper scroll case 283 in a state where the upper scroll case 283 and the lower scroll case 284 are combined with each other.

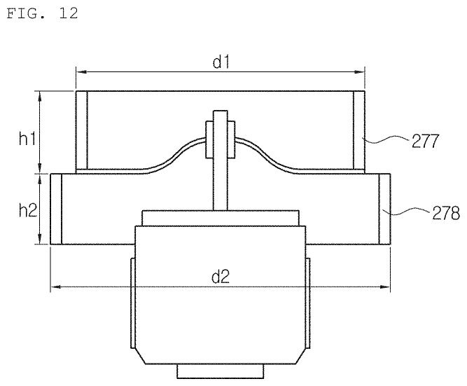

FIG. 12 is a view showing the blower wheel of the two-layered air conditioner for a vehicle according to the embodiment of the present invention. Referring to FIG. 12, a diameter (d2) of the second blower wheel 278 and a diameter (d2) of the second blower wheel 278 are different from each other. Preferably, the diameter (d2) of the second blower wheel 278 is larger than the diameter (d1) of the first blower wheel 277. Because the second scroll (lower scroll) is more complicated and narrower in an introduction path of air than the first scroll (upper scroll), the second scroll is high in pressure and resistance and is deteriorated in air-conditioning performance. The blower wheel supplements insufficient air volume of the second scroll and air-conditioning performance since the diameter (d2) of the second blower wheel 278 is larger than the diameter (d1) of the first blower wheel 277.

Additionally, a height (h1) of the first blower wheel 277 is larger than a height (h2) of the second blower wheel 278. A height of the blower unit 200 must be lower than a predetermined height in an aspect of a package standard. Therefore, the first blower wheel 277 or the second blower wheel 278 is formed to be low. Because the height (h2) of the second blower wheel 278 is lower than the height (h1) of the first blower wheel 277, a package height of the blower unit becomes lower and the blower wheel structure that the diameter is greater than the height is favorable to inhale and blow the air of the vertical direction in the radial direction.

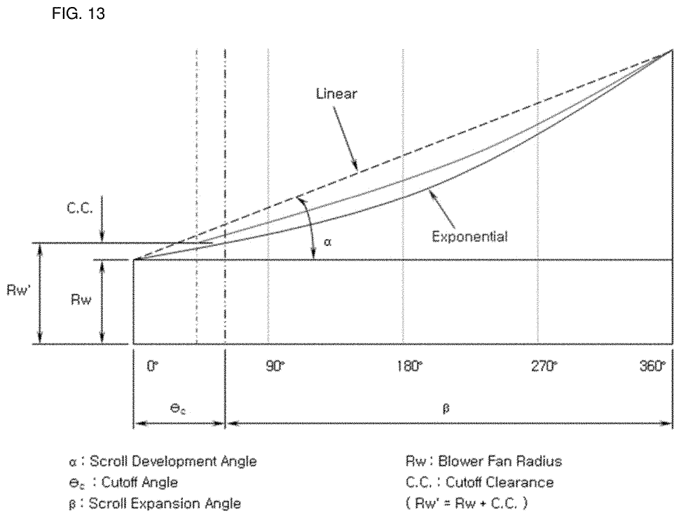

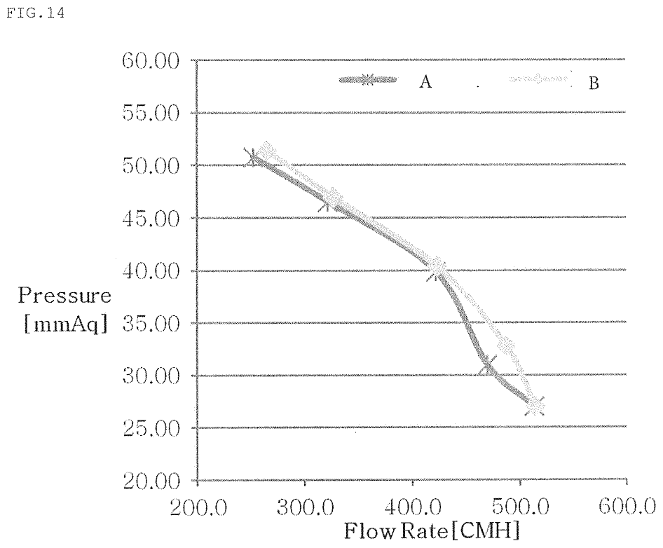

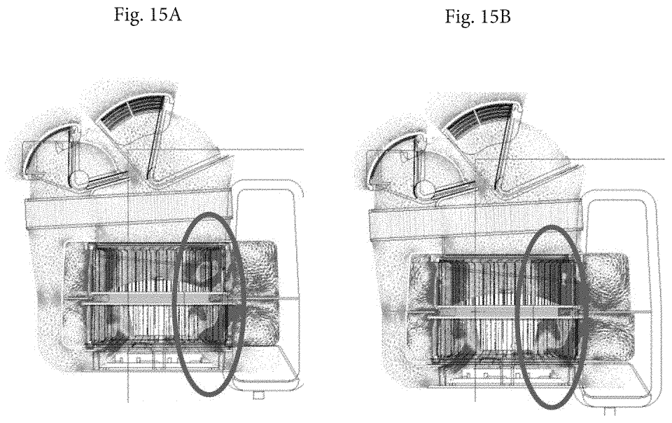

FIG. 13 is a graph for explaining a scroll expansion angle of the two-layered air conditioner for a vehicle according to the embodiment of the present invention, and FIGS. 14 and 15 are graphs for explaining an air-conditioning performance improvement result according to the scroll expansion angle.

Referring to FIGS. 13, 14, 15A and 15B, the scroll case expands the scroll while the distance between the center of the blower wheel and the outer wall surface is varied according to angles from the “cut off” point in FIG. 11, and the scroll case can be divided as shown in FIG. 13 according to expansion methods of angles. The blower unit according to the embodiment of the present invention adopts an “exponential” expansion method, and can optimize a scroll design since the expansion angle of the first scroll is 5.5° and the expansion angle of the second scroll is 6.3°.

Referring to FIG. 13, a formula of a “linear’ scroll development of the scroll case is defined as He=Rw×(1+tan(α)).

In addition, a formula of an “exponential’ scroll development of the scroll case satisfies

He=Rw×(1+2π×tan(α))^{θ÷2π},(0≤θ≤2π)

He′=Rw ′×(1+2π×tan(α′))^{θ′÷2π},(0≤θ′≤2π−θc,θ′=θ−θc).

Referring to FIG. 14, line A is that the expansion angle of the first scroll is equal to the expansion angle of the second scroll, and line B is that the expansion angle of the first scroll is 5.5° and the expansion angle of the second scroll is 6.3°. In case of line A, it is confirmed that pressure drops sharply in a flow rate zone of about 400 to 500 [CMH]. On the other hand, line B shows a relatively uniform pressure distribution according to the flow rate and compression is better.

Moreover, referring to FIG. 15B, compared with FIG. 15A, shows a relatively uniform speed distribution. Especially, FIG. 15A which is the scroll case having the same expansion angle at upper and lower sides near to the air outlet of the scroll case indicated by a red circle shows that blue color is partially shown at several parts, and it shows that speed distribution is not uniform. On the other hand, FIG. 15B which is the scroll case of which a lower expansion angle is larger than an upper expansion angle does not show blue color and shows a relatively uniform speed distribution.

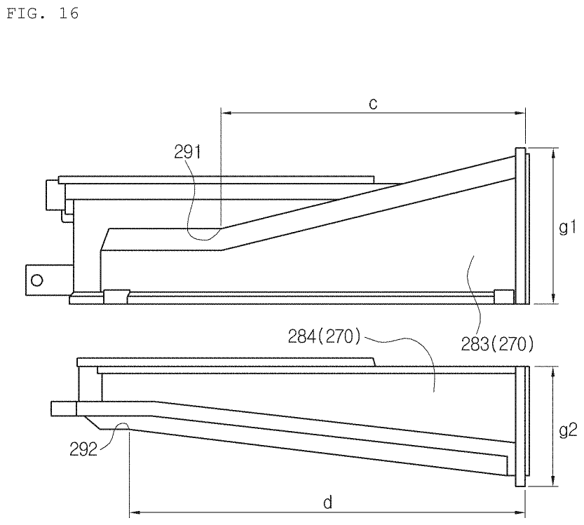

Meanwhile, FIG. 16 is a front view showing a state where the scroll case is separated.

Referring to FIG. 16, a start point of the scroll development part of the first scroll and a start point of the scroll development part of the second scroll are different from each other. Preferably, the start point of the scroll development part of the first scroll in the air flow direction is formed to be further back than the start point of the scroll development part of the second scroll. That is, a distance (c) between the start point 291 of the scroll development part of the upper scroll case 283 and an end portion of the air outlet is shorter than a distance (d) between the start point 292 of the scroll development part of the lower scroll case 284 and the end portion of the air outlet. Furthermore, a height (g1) of the upper scroll case 283 is higher than a height (g2) of the lower scroll case 284.

The lower scroll case 284 is deteriorated in air-conditioning performance since being more complicated in air introduction path and being narrower than the upper scroll case 283. Therefore, if the upper scroll case and the lower scroll case are designed in such a way that the scroll development part of the upper scroll case and the scroll development part of the lower scroll case are located at the same position, air-conditioning performance is deteriorated since the upper scroll case is not compressed sufficiently. Like the embodiment of the present invention, since the scroll development start point of the upper scroll case 283 is later than that of the lower scroll case 284, the scroll case has two air introduction paths so as to effectively overcome shortcomings of the conventional air conditioner.

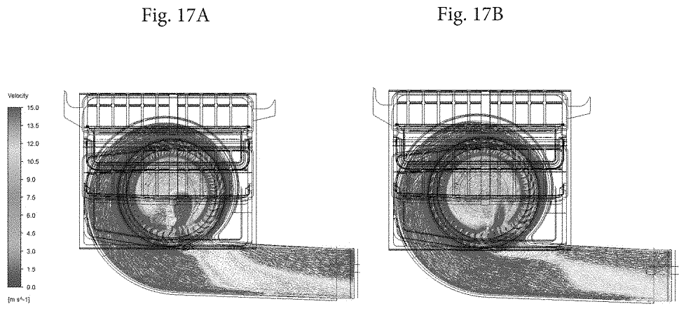

FIGS. 17A, 17B, 18 and 19 are graphs for explaining an air-conditioning performance improvement result according to the start point of the scroll development part according to the embodiment of the present invention. FIG. 17A shows that the start point of the scroll development part of the first scroll is equal to the start point of the scroll development part of the second scroll, and FIG. 17B shows that the start point of the scroll development part of the first scroll is formed to be further back than the start point of the scroll development part of the second scroll.

Referring to FIG. 17B, compared with FIG. 17A shows that the speed distribution is relatively uniform. Especially, FIG. 17A shows that blue color is partially shown at several parts near to the air outlet of the scroll case of FIGS. 17A and 17B, and it shows that speed distribution is not uniform. On the other hand, FIG. 17B does not show blue color and shows a relatively uniform speed distribution.

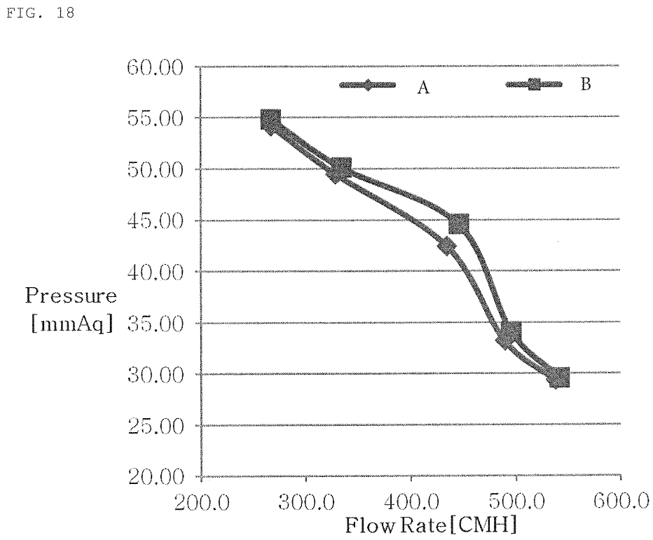

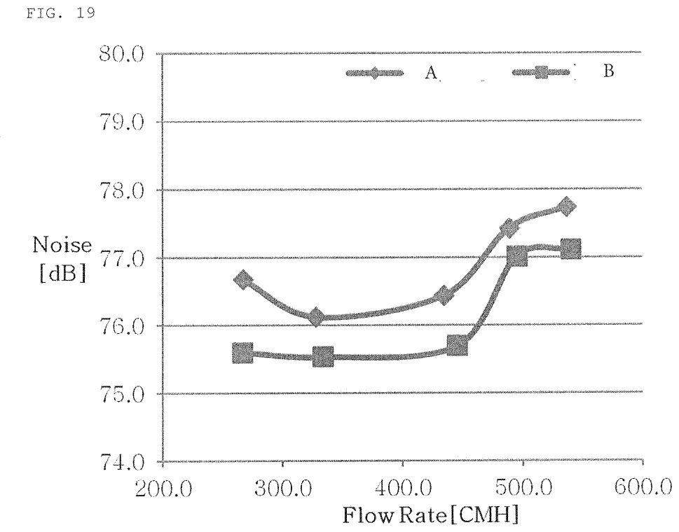

Referring to FIG. 18, line A compared with line B shows that pressure according to the flow rate is relatively low, and referring to FIG. 19, line A compared with line B shows that noise is relatively bigger.

While the present invention has been particularly shown and described with reference to exemplary embodiments thereof, it will be understood by those of ordinary skill in the art that various modifications and equivalents may be made without deviating from the spirit or scope of the invention. Therefore, it would be understood that the technical and protective scope of the present invention shall be defined by the technical idea as defined by the following claims and the equivalences.

1. A blower unit of a two-layered air conditioner for a vehicle, which separates and blows indoor air and outdoor air, comprising:
a first scroll in which a first blower wheel is disposed and a first air passageway is formed; and
a second scroll arranged below the first scroll, and having a second blower wheel and a second air passageway,
wherein a diameter of the second blower wheel and a diameter of the first blower wheel are different from each other.

2. The blower unit of the two-layered air conditioner according to claim 1, wherein the diameter of the second blower wheel is larger than that of the first blower wheel.

3. The blower unit of the two-layered air conditioner according to claim 1, wherein a scroll expansion angle of the first scroll and a scroll expansion angle of the second scroll are different from each other.

4. The blower unit of the two-layered air conditioner according to claim 3, wherein the scroll expansion angle of the second scroll is larger than that of the first scroll.

5. The blower unit of the two-layered air conditioner according to claim 1, wherein a height of the first blower wheel is greater than a height of the second blower wheel.

6. The blower unit of the two-layered air conditioner according to claim 1, wherein the scroll expansion angles of the first scroll and the second scroll are formed in such a way that a distance between the center of the blower wheel and the outer wall surface gets farther from a “cut off” point.

7. The blower unit of the two-layered air conditioner according to claim 3, wherein the scroll expansion angle of the first scroll is 5.2° to 5.8°, and the scroll expansion angle of the second scroll is 6.0° to 6.6°.

8. A blower unit of a two-layered air conditioner for a vehicle, which separates and blows indoor air and outdoor air, comprising:
a first scroll in which a first blower wheel is disposed and a first air passageway is formed; and
a second scroll arranged below the first scroll, and having a second blower wheel and a second air passageway,
wherein a start point of a scroll development part of the first scroll and a start point of a scroll development part of the second scroll are different from each other.

9. The blower unit of the two-layered air conditioner according to claim 8, wherein the start point of the scroll development part of the first scroll in the air flow direction is formed to be further back than the start point of the scroll development part of the second scroll.

10. The blower unit of the two-layered air conditioner according to claim 1, wherein the air passageway of the second scroll is more complicated than the air passageway of the first scroll.

11. The blower unit of the two-layered air conditioner according to claim 1, wherein the air passageway of the second scroll is larger in air resistance than the air passageway of the first scroll.

12. The blower unit of the two-layered air conditioner according to claim 1, wherein the first scroll includes an upper scroll case, and the second scroll includes a lower scroll case joined below the upper scroll case, and
wherein the upper scroll case receives the air which is introduced into the blower unit and directly flows downwards, and the lower scroll case receives the air which is introduced into the blower unit, flows downwards and bypasses and flows upwards.
